(19) United States
(12) Patent Application Publication
(10) Pub. No.: US 2013/0024216 A1
(43) Pub. Date: Jan. 24, 2013

(54) APPARATUS AND METHOD FOR EXPEDITED EVENT ACCESS

(71) Applicant: David B. Fink, Bethesda, MD (US)

(72) Inventor: David B. Fink, Bethesda, MD (US)

(21) Appl. No.: 13/185,659

(22) Filed: Jul. 19, 2011

(51) Int. Cl. G06Q 10/00; G06Q 30/00; G07B 15/00; G06K 5/00

(52) U.S. Cl. 705/5; 235/382; 705/14.36; 705/13

(57) ABSTRACT

A computer implemented method and apparatus of the present invention relates to the creation of a tangible result in the form of a priority access ticket with identifiable information for providing priority access to artistic performances, concerts, sporting or other cultural events at stadiums or other venues. The method may comprise receiving a request for priority access to a venue for a customer, collecting customer information required to provide priority access to the venue responsive to receipt of the request, verifying availability of priority access for the customer based on the collected customer information, receiving payment for the requested priority access, and providing a visually perceptible priority access ticket responsive to the verification of availability of priority access.

### FIELD OF THE INVENTION

The present invention relates generally to a system and method for obtaining expedited entry to artistic performances, concerts, sporting, and other cultural events held at stadiums or other venues requiring both ticketed entry and security checks.

### BACKGROUND OF THE INVENTION

A time-consuming inconvenience for patrons of artistic performances, concerts, sporting and cultural events is that attendees generally have to wait in a long line to go through security checks before they can enter the venue for the event. Such venues may include, but are not limited to, stadium, bar, amphitheater, bowl, circus, coliseum, course, diamond, field, gridiron, ground, gym, hotels, gymnasium, hippodrome, ice, park, pit, platform, ring, rink, stage, club, lodge, etc. These security checks may involve pat downs, walking through metal detectors, and inspection of an attendee's bag, clothing, and/or belongings. Many attendees complain that these security check lines are too long, move too slowly, and impede their ability to attend the entire event on time. Sometimes, attendees may end up spending almost as much time in these security lines as they may in watching the performance, concert, or sporting event.

Standing in these long lines at security checkpoints may also lead to frustration among attendees and may sometimes lead to tempers flaring up when the long wait-time stresses the attendees. Women and children standing in line for a security check may feel particularly uncomfortable and unsafe due to waiting in these lines for a long time with an anxious crowd at a concert or sporting event that is loud and rowdy, especially if the consumption of alcohol is a factor. People who do not drink, curse, or smoke may also be subjected to a potentially offensive environment while waiting a long period of time to get into such venues. Almost all venues prohibit smoking in the seating area, but people who do not smoke are subjected to second hand smoke while in close quarters with lots of people waiting for the security check prior to entering the venue.

A recent example of the problems that these long security check lines create was evident at Super Bowl XLV held at the Dallas Cowboy's football stadium on Feb. 6, 2011. The security checkpoints at the Dallas Cowboy's stadium created a massive bottleneck for football fans trying to gain access prior to the start of the event. As a result, some football fans missed a good portion of Super Bowl XLV and their enjoyment of the event was severely marred.

These lines for security checks may be most clogged up about 30 to 45 minutes before the start of the event as most people arrive at the venue during that time. Moreover, the wait in these security check lines tends to be much longer in cold weather due to the need to check thicker and more concealing outer garments and because attendees have to open up their jackets and layers of clothing for the security check. The long wait for security checks reduces the enjoyment that attendees derive from the event even before the event commences.

The attendees, having waited for an unreasonably and inconvenient amount of time to get through a security check point, may be in a hurry to get to their seat to enjoy the event and may bypass the food, beverage, and souvenir stands put up by the event's organizers, causing the organizers to lose anticipated revenues. One or more embodiment of the present invention may address these and other problems related to gaining entry to venues for performances, concerts, sporting and cultural events in a timely manner.

### SUMMARY OF THE INVENTION

Responsive to the foregoing challenges, Applicant has developed a computer implemented method for providing customers with priority access to events at a venue, comprising the steps of: receiving at a computer, a request for priority access to a venue for a customer; collecting customer information required to provide priority access to the venue responsive to receipt of the request; verifying availability of priority access for the customer based on the collected customer information; and providing a visually perceptible priority access ticket responsive to the verification of availability of priority access.

Applicant has also developed a computer implemented method for providing a customer with priority access to events at a venue, comprising the steps of: receiving at a computer, a request for priority access to a venue for a customer; collecting customer information required to provide priority access to the venue responsive to receipt of the request; verifying availability of priority access for the customer based on the collected customer information; receiving payment for the requested priority access; and providing a visually perceptible priority access ticket responsive to the verification of availability of priority access.

Applicant has also developed a computer implemented method for providing a customer with priority access to events at a venue, comprising the steps of: receiving at a computer, a request for priority access to a venue for a customer; collecting customer information required to provide priority access to the venue responsive to receipt of the request; verifying availability of priority access for the customer based on the collected customer information; receiving payment for the requested priority access; providing a visually perceptible priority access ticket responsive to the verification of availability of priority access wherein the priority access ticket contains a unique identifier; and storing the unique identifier on a non-transitory computer-readable medium using a computer.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is an exemplary system interaction diagram depicting components of a Priority Access system in accordance with an embodiment of the present invention.

FIG. 2 is an exemplary system interaction diagram illustrating the manner in which users of the Priority Access system may interact with the system in accordance with an embodiment of the present invention.

FIG. 3 is an exemplary diagram of a process for granting priority access to a venue for a user of the system at a Priority Access location in accordance with an embodiment of the present invention.

### DETAILED DESCRIPTION OF EMBODIMENTS OF THE INVENTION

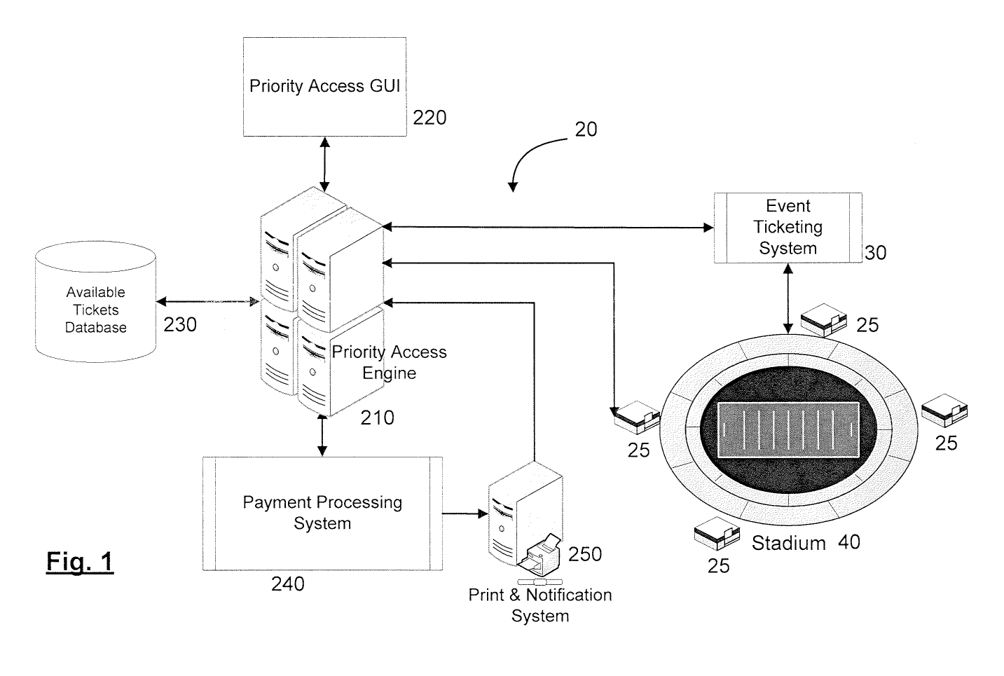

Reference will now be made in detail to system and method embodiments of the present invention, examples of which are illustrated in the accompanying drawings. With reference to FIG. 1, the system and method of the present invention relates to the creation of a tangible result in the form of a notification that may be rendered in a visibly perceptible output, such as but not limited to a printed ticket, for providing expedited (i.e., “priority”) access to artistic performances, concerts, sporting or other cultural events at venues, such as, stadiums 40. Customers using the Priority Access system 20 may be able to bypass regular lines and may be able to enter quickly the stadium 40 for events they desire to attend.

The components of an exemplary embodiment of the Priority Access system 20 together with the stadium 40, the priority access stadium location 25, and the stadium's event ticketing system 30 are illustrated in FIG. 1. As shown in FIG. 1, the Priority Access system 20 may include a Priority Access Engine 210, a Priority Access Graphical User Interface 220 (also referred to as “GUI”), an Available Tickets Database 230, a Payment Processing System 240, and a Print and Notification System 250 connected via a network. The GUI also may be connected through the network to one or more computers (including processing and memory devices) that collectively provide through hardware and/or software implementation the Priority Access Engine 210 (also referred to as “PAE”). The network may preferably be or include the Internet, but also may be or include any wired or wireless connection means that permit the transmission of electronic information. The PAE 210 may have a dedicated database assigned to it and may be connected via wired or wireless connection to an Available Tickets Database 230. The PAE 210 may also be connected via wired or wireless connection to one or more computers (including processing and memory devices) that collectively provide through hardware and/or software implementation a Payment Processing System 240 (also referred to as “PPS”). The PPS 240 and the PAE 210 may also be connected via wired or wireless connection to one or more computers (including processing and memory devices) that collectively provide through hardware and/or software implementation a Print and Notification System (also referred to as “PNS”) 250.

As shown in FIG. 1, the PAE 210 may also be connected through the network to one or more computers (including processing and memory devices) that collectively provide through hardware and/or software implementation an Event Ticketing System 30. As shown in FIG. 1, the Event Ticketing System 30 may be connected through a network to one or more computers (including processing and memory devices) representing the stadium 40. The network connecting the PAE 210 to the Event Ticketing System 30, and Event Ticketing System 30 to the one or more computers representing the stadium 40 may preferably be the Internet, but may be any wired or wireless connection means that permit the transmission of electronic information. As shown in FIG. 1, four priority access stadium locations 25 may be set up around a stadium 40 for priority access. Depending on need and configuration, the priority access stadium location 25 at any particular stadium 40 may be more or less than four. These priority access stadium locations 25 may be connected through a network to the PAE 210. The network may preferably be the Internet, but may be any wired or wireless connection means that permit the transmission of electronic information.

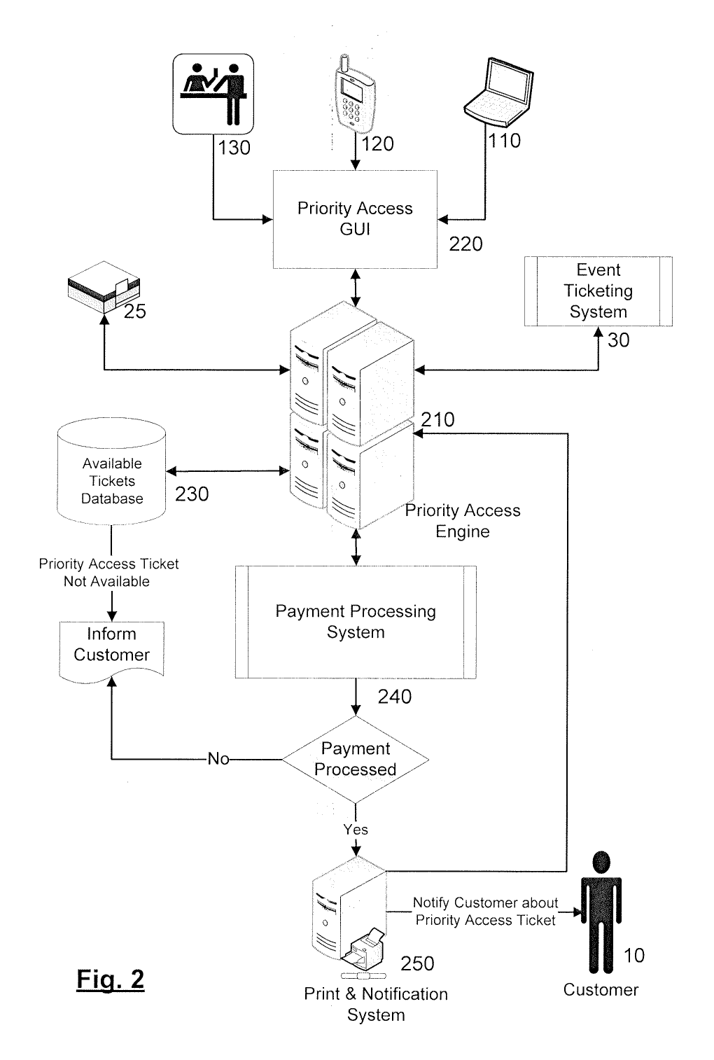

An embodiment of the present invention is shown in FIG. 2. In FIG. 2, a customer 10 who desires priority access to events at stadium 40 may purchase a priority access ticket using the GUI 220. The GUI 220 may be implemented using software on a general-purpose computer, such as a personal computer or laptop 110. Both wired and wireless computing devices for supporting the GUI 220 are within the intended scope of the present invention. The GUI 220 may be accessible on mobile devices 120 such as, smart phones or a personal digital assistant (“PDA”). The GUI 220 may render information that may be required for purchasing priority access tickets to events at stadium 40 available to customer 10 as a visibly perceptible output. The GUI 220 may accept input from customer 10 and transfer the information to PAE 210 for processing. The customer who desires priority access to events at stadium 40 may also purchase priority access through priority access stadium location 25 or a regular ticket booth 130 at stadium 40. Alternatively, customer 10 may call a customer service representative to purchase priority access tickets through the Priority Access system 20.

As shown in FIG. 2, the Available Tickets Database 230 may store information related to tickets that are eligible for priority access for various events at stadiums 40 where priority access is available. The PAE 210 may use information stored in the Available Tickets Database 230 to verify whether a priority access ticket for a particular event at a specific stadium 40 is presently available or not. The PAE 210 may adjust the number and/or the price of available priority access tickets in the Available Tickets Database 230 based on the wait time to enter the stadium for an event. The Available Tickets Database 230 may have a database comprising one or more computers (including processing and memory devices) that collectively provide a data storage and management device through hardware and/or software implementation. The Available Tickets Database 230 and the database for PAE 210 may have separate dedicated physical databases assigned to them. Alternatively, the Tickets Database 230 and the database for PAE 210 may share the same physical database with logical and software based partitions. These databases may be any type of data repository including, for example, an SQL table or ASCII text file.

As shown in FIG. 2, the PPS 240 may provide services related to the processing of payments for purchase of priority access tickets for events at stadium 40. The payments processed by the PPS 240 may include, but are not limited to, checks, credit card payments, PayPal payments, Google Checkout payments, T-Cash, clearXchange, QuickTap, Google Wallet, and other forms of mobile payment services that may or may not utilize near-field communication. The PPS 240, in an alternative embodiment, may authorize issuance of a priority access ticket to a customer without the need for payment. For example, the PPS 240 may award priority access tickets to customers based on factors such as time, seat location, event ticket price, or even randomly. The PPS 240 may be a special use computer with permanent programming to accomplish the methods described herein, or a general use computer programmed with software to permit it to accomplish the methods described herein. Alternatively, the PPS 240 may be implemented using any commercially available software, including, but not limited to, authorize.net's payment processing gateway, ACH Processing Solutions, Verisign Payflow Link, etc.

As shown in FIG. 2, the PNS 250 may notify customer 10 of a successful purchase or acquisition of a priority access ticket for an event at stadium 40. PNS 250 may also provide customer 10 with the priority access ticket that may be rendered as a visibly perceptible output. The priority access ticket may contain identifiable information to provide its holder priority access to events at stadium 40. The identifiable information for customer 10 may comprise one, or more, of name, address, driver license number, radio-frequency identification (RFID), number, retina, voice, thermal, finger or hand geometry signature, magnetic identifiers, barcodes, other biometric identifiers, or a visual identification of customer 10 or the like. If customer 10 buys a priority access ticket at a priority access stadium location 25 or a regular ticket booth 130, PNS 250 may also be configured to generate a physical copy of the priority access ticket. The physical copy of the priority access ticket may include, but is not limited to, bar-coded tickets, magnetic-stripe encoded or “smart” cards, punch-type cards, coded tokens, or tickets with biometric identifiers. The identifiable information for customer 10 may be such that it can be recognized by a keypad, card reader, scanning device, or similar device located at the priority access stadium location 25. The PNS 250 may be a special use computer with permanent programming to accomplish the methods described herein, or a general use computer programmed with software to permit it to accomplish the methods described herein. Alternatively, the PNS 250 may be implemented using any commercially available software.

As shown in FIG. 2, the event ticketing system 30 may provide information related to the availability of tickets for any specific event at a particular stadium 40 to PAE 210. The event ticketing system 30 may be a special use computer with permanent programming to accomplish the methods described herein, or a general use computer programmed with software to permit it to accomplish the methods described herein. Alternatively, the event ticketing system 30 may be implemented using any commercially available tool, including, but not limited to, SeatAdvisor Box Office (“SABO”) Arts, SABO Sports, SABO University, ShowClix Simply Ticketing, etc. The event ticketing system 30 may be connected to the PAE 210 through a network. The event ticketing system 30 may also be connected through a network to one or more computers (including processing and memory devices) that collectively provide through hardware and/or software implementation a representation of the event and the facilities available at the stadium 40. The network connecting the event ticketing system 30 to the PAE 210 and the stadium 40 may preferably be the Internet, but may be any wired or wireless connection means that permit the transmission of electronic information.

As shown in FIG. 2, the PAE 210 may also be connected through a network to one or more computers (including processing and memory devices) that collectively provide through hardware and/or software implementation a priority access stadium location 25. The network connecting the priority access stadium location 25 to the PAE 210 may preferably be the Internet, but may be any wired or wireless connection means that permit the transmission of electronic information. The priority access stadium location 25 computer may be configured to communicate with the PAE 210 for purchasing priority access tickets and for validating identifiable information on the priority access tickets. The priority access stadium location 25 may have a special use computer with permanent programming to accomplish the methods described herein, or a general use computer programmed with software to permit it to accomplish the methods described herein. The computer at the priority access stadium location 25 may include one or more of processing and memory devices, user interface having a video monitor, keyboard, printer, and a keypad, card reader, scanning device, or similar device that can recognize the identifiable information on the priority access ticket.

The collective components of the Priority Access system 20 may be implemented as computer programs and associated database(s) that are run on, and provide storage for, general-purpose computers having memory and/or processing capabilities. Furthermore, these components may be used to collect, transform, and apply data in such a way as to produce a tangible result, including, but not limited to, the creation of priority access tickets that may be in the form of bar-coded tickets, magnetic-stripe encoded or “smart” cards, punch-type cards, coded tokens, barcodes on the display screens of mobile devices, or tickets with biometric identifiers. These visually perceptible tickets may be imprinted with identifiable information comprising one, or more, of name, address, driver license number, barcodes, radio-frequency identification (RFID), number, retina, voice, thermal, finger or hand geometry signature, magnetic identifiers, barcodes, other biometric identifiers, or a visual identification of customer 10 or the like. In an alternative embodiment, the event ticket may itself also serve as the priority access ticket and be recognized as such by ticket reading equipment at the priority access stadium locations 25.

According to an embodiment of the present invention shown in FIGS. 1 and 2, if customer 10 desires to purchase a priority access ticket, then customer 10 may access the GUI 220 of the Priority Access system 20 through a personal computer/laptop 110 or a mobile device 120 to commence a transaction to purchase or otherwise obtain a priority access ticket. The GUI 220 may be used to collect all the information that may be required to purchase or obtain priority access tickets for a specific event at a particular stadium 40. Customer 10 may also purchase priority access tickets at a priority access stadium location 25 or a regular ticket booth 130 at the stadium 40 that is equipped to issue priority access tickets. Alternatively, customer 10 may contact a customer service representative through wired or wireless telephones to purchase priority access tickets through the Priority Access system 20.

When the GUI 220 conveys the request to purchase priority access tickets to PAE 210, the PAE 210 may verify with the Available Tickets Database 230 whether priority access tickets for a particular event at a specific stadium 40 is available. If the Available Tickets Database 230 indicates that priority access tickets are not available, customer 10 may be informed of the unavailability of priority access tickets, which may be rendered as a visibly perceptible output on the GUI 220. If the Available Tickets Database 230 indicates that priority access tickets are available, then the PAE 210 invokes the PPS 240 for processing the payment to purchase priority access tickets. If the PPS 240 is unable to process the payment for customer 10, for example, because of denial of credit card or the lack of sufficient funds in the PayPal account, customer 10 may be informed of the unsuccessful payment, which is rendered as a visibly perceptible output on GUI 220. Customer 10 may be given another opportunity to provide an alternate method of payment for purchasing priority access tickets. If the PPS 240 successfully processes the payment for the priority access tickets, customer 10 may be informed of the successful purchase of priority access tickets, which may be rendered as a visibly perceptible output on GUI 220.

The PPS 240 may also inform customer 10 of his purchase of priority access tickets by e-mail or text messages sent to the e-mail or cell phone number provided by customer 10 when requesting priority access tickets. The e-mail may also contain a priority access ticket with identifiable information that may be rendered in a visibly perceptible output. Customer 10 may print the ticket and bring it to a priority access stadium location 25 or any regular ticket booth equipped to handle priority access for entering the stadium 40. Alternatively, the customer's event ticket may serve as the priority access ticket after the equipment at the priority access stadium locations 25 are notified to recognize the event ticket as a priority access ticket.

In another exemplary embodiment, if customer 10 purchases priority access tickets at priority access stadium location 25 or a regular ticket booth equipped to handle priority access, a physical copy of the priority access ticket with identifiable information may be generated and delivered to customer 10. In another exemplary embodiment, if customer 10 already has a regular ticket, then the identifiable information for priority access may be printed on the regular ticket of customer 10 or customer 10 may be given a priority access token with identifiable information printed thereon.

In another exemplary embodiment, the priority access tickets may be sent to customer 10 in the form of a barcode image or other identifiable information that may be displayed on the display screen of the mobile device 120. Customer 10 may use the mobile device 120 at the priority access stadium location 25 to validate their priority access to the event by holding the mobile device 120 up to a scanning device. Customer 10 may also validate their priority access using the mobile device 120 at any regular ticket booth equipped to handle priority access. In another exemplary embodiment, on purchasing a priority access ticket, the mobile device 120 of customer 10 may be activated to grant priority entry for a specific event at a particular stadium 40 utilizing the near-field communication capabilities of the mobile device 120. After customer 10 is informed of his purchase of priority access tickets, the PPS 240 may notify the PAE 210 to update the Available Tickets Database 230. The PPS 240 may also send the identifying information for each priority access ticket to PAE 210. This identification information may be used for validation of the priority access ticket when it is presented by customer 10 for priority access to an event at stadium 40.

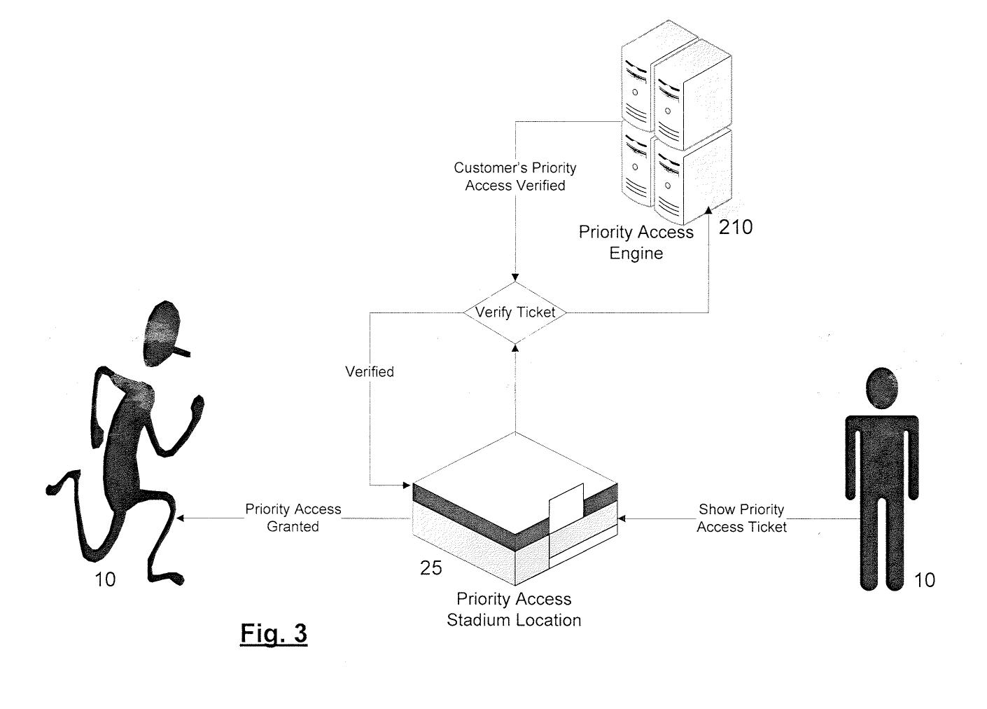

As shown in FIG. 3, when the priority access ticket is presented to the priority access stadium location 25 or a regular ticket booth at the stadium 40 that is equipped to read and interpret the priority access ticket, the PAE 210 may be accessed to verify if customer 10 is eligible for priority access. Alternatively, the eligibility for priority access may be verified locally at the priority access stadium location 25 without accessing the PAE 210. If customer 10 has purchased a valid priority access ticket, customer 10 may be given priority access to the event at stadium 40.

In addition to the cost of the ticket for the event at stadium 40, an additional fee may be charged for each priority access. Alternately, a yearly subscription fee or a one-time fee may be charged to customer 10 for using the Priority Access system 20. The revenue from the Priority Access system 20 may be shared with the stadium owner, operator, event organizer, or team owner. The revenue from the Priority Access system 20 may also be used for things besides access, for example, part of the revenue may go to charity, part of the revenue may go to retired NFL/NHL/NBA/MLB or other professional or college sports players or for their medical care, part of the revenue may provide customer 10 with a discount for merchandise or food purchases, part of the revenue may provide customer 10 with special parking privileges, part of the revenue may be tied to a season ticket, a personal seat license, corporate sponsorship, etc. Priority access privileges may be revoked if the customer brings unauthorized items into the stadium 40 using priority access provided by the Priority Access system 20 or violates any rules of conduct at stadium 40.

The foregoing method preferably may be used in “real time” meaning that priority access tickets may be purchased or otherwise obtained the day of and within hours or even minutes before, and or after the start of, an event to be attended. As a result, the availability of priority access tickets may be continuously updated in real time based on the wait time at the priority access stadium locations. Furthermore, the price of a priority access ticket may be varied in real time based on the wait time at the priority access stadium locations. This “wait time” information may be collected using any number of techniques known to estimate the time required to pass through security at a priority access stadium location. For example, wait time may be determined using a computer to monitor the time it takes a cellular telephone or other handheld device for which location information can be derived to pass from one location associated with the priority access waiting line to another location associated with having passed through security.

As will be understood by those skilled in the art, the invention may be embodied in other specific forms without departing from the spirit or essential characteristics thereof. For example, the particular architecture depicted above is merely exemplary of one implementation of the present invention. The functional elements and method steps described above are provided as illustrative examples of one technique for implementing the invention; one skilled in the art will recognize that many other implementations are possible without departing from the present invention as recited in the claims. In addition, the present invention may be implemented as a method, process, user interface, computer program product, system, apparatus, or any combination thereof. Accordingly, the disclosure of the present invention is intended to be illustrative, but not limiting, of the scope of the invention. It is intended that the present invention cover all such modifications and variations of the invention, provided they come within the scope of the appended claims and their equivalents.

What is claimed is:

1. A computer implemented method for providing customers with priority access to events at a venue, comprising the steps of:
receiving at a computer, a request for priority access to a venue for a customer;
collecting customer information required to provide priority access to the venue responsive to receipt of the request;
verifying availability of priority access for the customer based on the collected customer information; and
providing a visually perceptible priority access ticket responsive to the verification of availability of priority access.

2. The method of claim 1, further comprising the step of receiving payment for the requested priority access responsive to verification of the availability of priority access.

3. The method of claim 1, wherein the collected customer information includes information selected from the group consisting of: name, age, gender, ticket identification, venue identification, seat identifier, gate identifier, venue attendance record, ticket type, date, and time information.

4. The method of claim 2, wherein at least a part of the payment for priority access is allocated to a charity of the customer's choice.

5. The method of claim 2, wherein at least a part of the payment for priority access is allocated to a predetermined charity.

6. The method of claim 2, wherein at least a part of the payment for priority access is allocated to medical care of retired professional sports players.

7. The method of claim 2, wherein at least a part of the payment for priority access is allocated to an owner or operator of the venue.

8. The method of claim 1, further comprising the step of providing a discount on merchandise or food purchases at the venue to the customer with priority access ticket.

9. The method of claim 1, further comprising the step of providing parking privileges at the venue to the customer with priority access ticket.

10. The method of claim 1, further comprising the step of providing priority access in return for corporate sponsorship.

11. The method of claim 1, further comprising the step of providing priority access to a customer with season ticket.

12. The method of claim 1, further comprising the steps of:
determining the wait time at a priority access stadium location; and
adjusting the number of priority access tickets that are available based on the wait time determination.

13. The method of claim 2, further comprising the steps of:
determining the wait time at a priority access stadium location; and
adjusting the price of priority access tickets based on the wait time determination.

14. A computer implemented method for providing a customer with priority access to events at a venue, comprising the steps of:
receiving at a computer, a request for priority access to a venue for a customer;
collecting customer information required to provide priority access to the venue responsive to receipt of the request;
verifying availability of priority access for the customer based on the collected customer information;
receiving payment for the requested priority access; and
providing a visually perceptible priority access ticket responsive to the verification of availability of priority access.

15. The method of claim 14, wherein the priority access ticket contains a unique identifier and the unique identifier is selected from the group consisting of: address, driver license number, radio-frequency identification (RFID), number, retina, voice, thermal, finger or hand geometry signature, magnetic identifiers, barcodes, visual identification, or other biometric identifiers.

16. The method of claim 15, further comprising the step of storing the unique identifier associated with the priority access ticket on a non-transitory computer-readable medium using a computer.

17. The method of claim 16, further comprising the steps of:
determining the unique identifier associated with the priority access ticket; and
providing priority access responsive to the determined unique identifier matching the stored unique identifier.

18. A computer implemented method for providing a customer with priority access to events at a venue, comprising the steps of:
receiving at a computer, a request for priority access to a venue for a customer;
collecting customer information required to provide priority access to the venue responsive to receipt of the request;
verifying availability of priority access for the customer based on the collected customer information;
receiving payment for the requested priority access;
providing a visually perceptible priority access ticket responsive to the verification of availability of priority access wherein the priority access ticket contains a unique identifier; and
storing the unique identifier on a non-transitory computer-readable medium using a computer.
